(19) United States
(12) Patent Application Publication
(10) Pub. No.: US 2001/0010604 A1
(43) Pub. Date: Aug. 2, 2001

(54) Sync detector for use in data storage system for detecting extended sync pattern

(76) Inventor: Atsushi Esumi, Ome-shi (JP)

Correspondence Address: Pillsbury Madison & Sutro, LLP, Ninth Floor, East Tower, 1100 New York Avenue, N.W., Washington, DC, 20005-3918, US

(21) Appl. No.: 09/772,909

(22) Filed: Jan. 31, 2001

(30) Foreign Application Priority Data
Jan. 31, 2000 (JP) 2000-022655

(51) Int. Cl. G11B 5/09

(52) U.S. Cl. 360/49; 360/51

(57) ABSTRACT

An extended sync pattern, which is comprised of a pattern portion at the end of a preamble pattern recorded immediately before an original sync pattern in a sector and the original sync pattern, is used in a sync detecting operation in place of the original sync pattern. This sync detecting operation is carried out by receiving read data from the storage medium, repeating an operation of extracting those symbols of data whose quantity coincides with the length of the extended sync pattern from the input data, while shifting an extraction start position by one symbol, and collating the extracted data with a collation pattern coincident with the extended sync pattern every time data extraction is executed.

### CROSS-REFERENCE TO RELATED APPLICATIONS

This application is based upon and claims the benefit of priority from the prior Japanese Patent Application No. 2000-022655, filed Jan. 31, 2000, the entire contents of which are incorporated herein by reference.

### BACKGROUND OF THE INVENTION

The present invention relates to a sync detector for use in a data storage system capable of reading data from a storage medium on which user data is recorded in recording areas of a predetermined size and a sync pattern is recorded in each recording area. More particularly, the invention relation to a sync detector for detecting an extended sync pattern including an original sync pattern.

A magnetic disk drive is known as a typical data storage system which can read data from a storage medium. This magnetic disk drive uses a magnetic disk storage medium as a storage medium for recording data. Concentrical tracks are formed on the recording surface of a magnetic disk storage medium. Each track consists of a plurality of recording areas. Data is recorded in the areas block by block which consists of a predetermined number of symbols. These area are called “data sector”.

It is essential for this type of magnetic disk drive to accurately detect the top symbol of data recorded on a disk storage medium. For this purpose, a sync pattern for data synchronization is written before data on each sector of a disk storage medium. The area where sync pattern is written is called “sync field”. The top symbol of data can be correctly detected by detecting the sync pattern in this sync field using a sync detector in the magnetic disk drive. That is, data synchronization can be achieved.

In the case where the sync pattern cannot be detected correctly, thus disabling data synchronization, if a reading operation takes place in that state, a read error occurs in which data off the timing by, for example, every several symbols, is read. This read error is a kind of burst error and is called “framing error”. The read error would appear over the entire sector. Such a large burst error cannot be corrected even by an error correcting code (ECC). Therefore, the detection of a sync pattern is an important factor that affects the performance of a magnetic disk drive.

Normally, the operation of the sync detector to detect a sync pattern (sync detecting operation) is carried out by collating a predetermined target sync pattern with the pattern of read data and counting the number of matched symbols. When the number of matched symbols is equal to or greater than a predetermined value, a signal indicating sync detection (sync detection signal) is output. The sync detection signal is used as a timing signal at the time serial data is converted to parallel data. The above is true of other data storage systems than a magnetic disk drive, such as a magneto-optical disk drive.

As mentioned above, a data storage system typified by a magnetic disk drive should detect a sync pattern to correctly detect the top symbol of data in order to access a sector or a recording area.

It is therefore important to improve the sync detection performance of the sync detector in a data storage system. One way of improving the sync detection performance is to increase (lengthen) the number of symbols (sync length) of a sync pattern.

As the sync length (sync pattern length) becomes longer, however, the amount of user data occupying information to be recorded on a disk storage medium decreases. This impairs the data format efficiency on the disk storage medium.

It is apparent that the prior art suffers a tradeoff relationship between improving the sync detection performance and increasing the data format efficiency.

### BRIEF SUMMARY OF THE INVENTION

Accordingly, it is an object of the present invention to provide a sync detector that can improve the sync detection performance without lowering the data format efficiency on a storage medium by using an extended sync pattern which is comprised of an original sync pattern and a part of at least one of data recorded immediately before and after the original sync pattern.

To achieve the above object, according to this invention, a sync detector for use in a data storage system capable of reading data from a storage medium on which user data is recorded in recording areas of a predetermined size and an original sync pattern is recorded in each of the recording areas, comprises a pattern collating unit for performing a sync detecting operation of detecting an extended sync pattern comprised of first and second sync patterns from read data from the storage medium, the first sync pattern being the original sync pattern while the second sync pattern is at least one of an end part of recorded data immediately before the original sync pattern and a top part of recorded data immediately after the original sync pattern.

The sync detector of the invention does not detect the original sync pattern. Rather, it detects an extended sync pattern containing the original sync pattern. The extended part of the extended sync pattern includes the data recorded immediately before the original sync pattern or the data recorded immediately after the original sync pattern, or both. Thus, the sync pattern can be practically lengthened, without using more symbols than those contained in the original sync pattern. This reduces the probability of sync errors, without lowering the data-formatting efficiency.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating the structure of a magnetic disk drive according to a first embodiment of this invention;

FIG. 2 is a diagram showing a sector data format used in this embodiment;

FIG. 3 is a diagram showing a read gate and a sync detection signal when a sync pattern in a sector has been detected correctly in association with the sector data format;

FIG. 4 is a diagram showing a read gate and a sync detection signal when a sync pattern has been detected before the correct sync detection position in association with the sector data format;

FIG. 5 is a diagram showing a read gate and a sync detection signal when sync detection is not possible in association with the sector data format;

FIG. 6 is a diagram for explaining sync detection and an unmatched symbol quantity Nm(Pi) for each sync detection position Pi;

FIG. 7 is a diagram for explaining an extended sync pattern;

FIG. 8 is a diagram for explaining a sync detection method which is employed in a sync detector 31 when an extended sync pattern is used;

FIG. 9 is a diagram depicting the unmatched symbol quantity Nm(Pi) for each sync detection position Pi when the sync detecting operation is executed using an original sync pattern;

FIG. 10 is a diagram depicting the unmatched symbol quantity Nm(Pi) for each sync detection position Pi when last two symbols of a preamble pattern are used as a part of the extended sync pattern under the same condition as given in the example of FIG. 9;

FIG. 11 is a diagram depicting the unmatched symbol quantity Nm(Pi) for each sync detection position Pi when last four symbols of the preamble pattern are used as a part of the extended sync pattern under the same condition as given in the example of FIG. 9;

FIG. 12 exemplifies a minimum number of unmatched bits, which has been obtained by using, as parameters, the sync length of the original sync pattern and the number of preamble bits used.

FIG. 13 shows error probability acquired by simulation in which an original sync pattern having a 12-bit length was used alone and, also the sync error probability acquired by simulation in which an extended sync pattern was used, which utilizes two bits in the preamble pattern and four bits in the preamble pattern.

FIG. 14 is a diagram showing the results of simulation of acquiring a sync error probability in the cases where each of original sync patterns having sync lengths of 8 bits, 12 bits and 16 bits was used alone and where an extended sync pattern using four bits of the preamble pattern was used;

FIG. 15 is a diagram showing a first modification of the extended sync pattern;

FIG. 16 is a diagram showing a second modification of the extended sync pattern;

FIG. 17 is a flowchart for explaining a sync detection method using an extended sync pattern according to a second embodiment of this invention;

FIG. 18 is a flowchart for explaining a sync detection method according to a third embodiment of the invention, in which switches a mode of executing a sync detecting operation using an original sync pattern and a mode of executing a sync detecting operation using an extended sync pattern between a normal time and a retry time;

FIG. 19A is a block diagram exemplifying the structure of the sync detector 31 which employs the sync detection method shown in FIG. 18;

FIG. 19B is a diagram showing the relationship between the logic statuses of a selective control input S of a MUX 192 and the contents of selected outputs of the MUX 192 in FIG. 19A; and

FIG. 20 is a flowchart for explaining a modification of the sync detection method illustrated in FIG. 18.

### DETAILED DESCRIPTION OF THE INVENTION

Several embodiments of the present invention as adapted to a magnetic disk drive will be described below with reference to the accompanying drawings.

[First Embodiment]

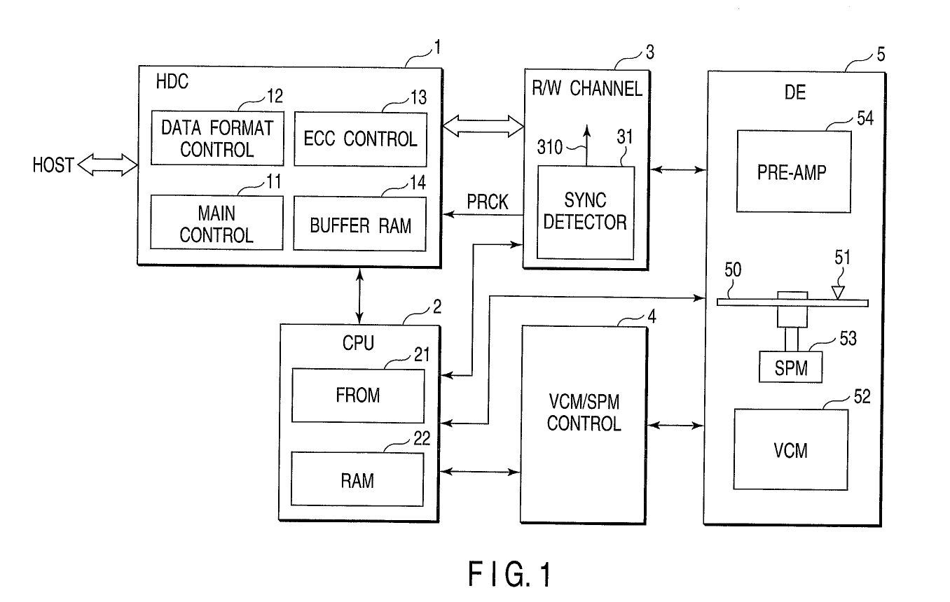

FIG. 1 is a block diagram illustrating the structure of a magnetic disk drive according to the first embodiment of the invention.

The magnetic disk drive in FIG. 1 mainly comprises a hard disk controller (HDC) 1, a CPU 2, a read/write (R/W) channel 3, a VCM/SPM controller 4 and a disk enclosure (DE) 5. Generally speaking, the HDC 1, CPU 2, R/W channel 3 and VCM/SPM controller 4 are constructed on the same board.

The HDC 1 has a main control unit 11 which controls the entire HDC 1, a data format control unit 12, an ECC control unit 13 and a buffer RAM (Random Access Memory) 14. The HDC 1 is connected via an interface section (not shown) to a host (host system) and connected to the R/W channel 3. The HDC 1 performs data transfer between the host and a magnetic disk drive under the control of the main control unit 11. A read reference clock (RRCK) which is generated in the R/W channel 3 is input to this HDC 1.

The data format control unit 12 converts data transferred from the host to a format suitable for recording on a disk storage medium (magnetic disk) 50. The data format control unit 12 also converts data reproduced from the disk storage medium 50 to a format suitable for transfer to the host.

The ECC control unit 13 adds redundant data (redundant symbol) to data to be recorded (information symbols) to ensure correction and detection of errors contained in data which is reproduced from the disk storage medium 50. The ECC control unit 13 determines if an error is present in the reproduced data and performs detection of the position of the error and correction of the error or detects the error position, when the error is in the data. Note that the number of error-correctable bytes is finite and has a certain relationship with the length of redundant data. Specifically, adding many redundant data can permit a greater number of errors to be corrected at the price of a lower format efficiency. Therefore, there is a trade-off relationship between the length of redundant data and the number of error-correctable bytes.

The buffer RAM 14 temporarily stores data (write data) transferred from the host. The write data temporarily stored in the buffer RAM 14 is transferred to the R/W channel 3 at the proper timing. The buffer RAM 14 also temporarily stores read data transferred from the R/W channel 3. The read data temporarily stored in the buffer RAM 14 is transferred to the host at the proper timing after ECC decoding or the like is completed.

The CPU 2 is connected to the HDC 1, the R/W channel 3, the VCM/SPM controller 4 and the DE 5. The CPU 2 has a FROM (Flash Read Only Memory) 21 as a rewritable nonvolatile memory and RAM 22. Stored in the FROM 21 is a control program necessary for the control operations the CPU 2 performs.

The R/W channel 3 is connected to the HDC 1 and the DE 5. The data to be recorded on the disk storage medium 50 and the data reproduced from the disk storage medium 50 are transferred between the R/W channel 3 and the DE 5. The R/W channel 3 sends a recording signal to the DE 5 and receives a reproduction signal therefrom. The R/W channel 3 is separated into a recording system (write channel) and a reproducing system (read channel), neither shown. The R/W channel 3 further has a sync detector 31 which directly pertains to this invention.

As well known, the recording system of the R/W channel 3 includes a scrambler, a run length limited (RLL) encoder, a data generator, a write precompensator and a write driver. The data that has been transferred from the HDC 1 is converted to a sequence which is suitable for recording by the scrambler and RLL encoder. The data generator generates a preamble pattern and sync pattern added to the head of data. The write precompensator performs precompensation on data affixed with the preamble pattern and sync pattern based on NLTS (Non-Linear Transition Shift). The write driver generates a recording signal from the precompensated data and sends it to the DE 5.

The reproducing system of the R/W channel 3 comprises well-known components, such as an automatic gain controller (AGC), sample and hold (S/H) circuit, a digital/analog (A/D) converter, an equalizer, a Viterbi detector, an RLL decoder and a descrambler, and the sync detector 31 which is directly relates to this invention. The reproduction signal that has been transferred from the DE 5 is first subjected to gain control by the AGC. The gain-controlled reproduction signal is sampled and held at a predetermined cycle by the S/H circuit and is then converted to digital data by the A/D converter. The equalizer performs equalization matched for a partial response class on this digital data. The Viterbi detector performs most-likely decoding on the equalized data. The data after this most-likely decoding is returned to original data by the RLL decoder and descrambler and this original data is then transferred to the HDC 1.

The sync detector 31 performs a sync detecting operation of detecting a sync pattern from read data reproduced by the R/W channel 3. In this example, the sync detector 31 carries out the sync detecting operation by collating the read data with a collation pattern which coincides with a target sync pattern and counting the number of matched symbols. When the number of matched symbols is equal to or greater than a predetermined value, the sync detector 31 outputs a sync detection signal 310 indicating that the sync pattern has been detected correctly. The sync detection signal 310 is used in a framing signal at the time of converting serial data to parallel data in HDC 1 and the R/W channel 3.

The VCM/SPM controller 4 controls a voice coil motor (VCM) 52 and a spindle motor (SPM) 53.

The DE 5 is connected to the R/W channel 3 and the VCM/SPM controller 4. The DE 5 includes the disk storage medium 50, a head (magnetic head) 51, the VCM 52, the SPM 53 and a pre-amplifier 54 which receives a recording signal from the R/W channel 3 and sends a reproduction signal thereto. FIG. 1 shows only one disk storage medium 50 and only one head 51 located at one side of the medium 50. Nonetheless, the DE 5 may of course have more disk storage media 50 and more heads 51. In this case, one head 51 may be provided at each side of each disk storage medium 50.

The recording signal sent from the R/W channel 3 is supplied to the head 51 via the pre-amplifier 54 in the DE 5, and is recorded on the disk storage medium 50 by the head 51. The signal that is read from the disk storage medium 50 by the head 51 is transmitted via the pre-amplifier 54 to the R/W channel 3.

The VCM 52 in the DE 5 moves the head 51 in the radial direction of the disk storage medium 50 to position the head 51 at a target position on the disk storage medium 50. The SPM 53 turns the disk storage medium 50.

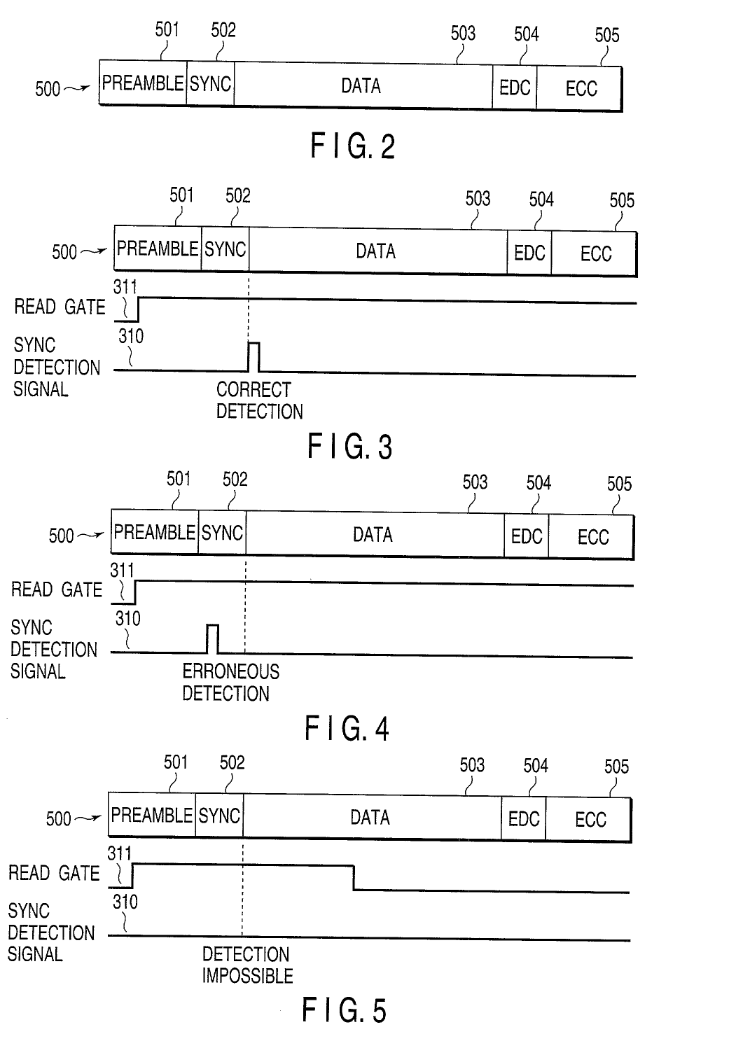

FIG. 2 shows the essential portions of a typical data format in one sector (data sector) 500 as a data recording unit on the disk storage medium 50. The sector 500 includes a preamble pattern 501, a sync pattern 502, a data (user data) field 503, an error detecting code (EDC) 504 and an error correcting code (ECC) 505. The preamble pattern 501 is used to perform the initial pulling of a phase-locked loop (PLL) circuit for setting a time interval (frequency) of data (data bits) to be reproduced. The sync pattern 502 is used to secure synchronization a the time of converting serial data to parallel data. The EDC 504 is a redundant symbol which is generated based on data set in the data field 503 and used to detect an error at the time of decoding the data. Decoding using this EDC 504 is called “ECC decoding”. The ECC 505 is generated based on the data set in the data field 503 and the EDC 504, and is used to detect and correct an error at the time of decoding the data and the EDC 504. Decoding using the ECC 505 is called “EDC decoding”. The probability of erroneous correction using the ECC can be reduced by correcting an error in data or the EDC 504 by executing the ECC decoding and then detecting an error by executing the EDC decoding.

A description will now be given of the case where the sync detector 31 has correctly detected the sync pattern 502 and the case where the sync detector 31 has not.

FIG. 3 shows a read gate 311 and the sync detection signal 310 when the sync pattern 502 in the sector 500 has been detected correctly in association with the data format of the sector 500. The read gate 311 is generated by the HDC 1 in association with each sector 500. As illustrated in the figure, when the sync pattern 502 is detected correctly, the sync detection signal 310 is output the timing of the correct position or the end position of the sync pattern 502. Then, data, the EDC and the ECC are read correctly.

When the sync pattern 502 is not detected correctly, possible causes are erroneous detection of the sync pattern 502 (erroneous sync detection) and disabled detection of the sync pattern 502 (disabled sync detection). The “erroneous sync detection” is the detection of the sync pattern 502 before the correct sync detection position. FIG. 4 shows the read gate 311 and the sync detection signal 310 in this case in association with the data format of the sector 500. As illustrated in the figure, in the case of erroneous sync detection, the read gate 311 keeps a high-level state as in the case where the sync pattern 502 is detected correctly. This allows the data in the data field 503, the EDC 504 and the ECC 505 to be read out with asynchronization, thus generating a framing error. In general, a framing error exceeds the level that can be corrected by the ECC, so that a read error occurs, followed by a retry operation.

The “disabled sync detection” is such an event that the sync pattern 502 is not detected. FIG. 5 shows the read gate 311 and the sync detection signal 310 in this case in association with the data format of the sector 500. As illustrated in the figure, in the case of the disabled sync detection, unlike the case where the sync pattern 502 is detected correctly, the read gate 311 becomes a low level at a midway timing in the sector 500. Therefore, the data in the data field 503, the EDC 504 and the ECC 505 cannot be read out and a retry operation takes place.

The probability that the sync pattern 502 is not detected correctly, i.e., the sync error probability, is determined by the sync-error detecting probability and the disabled sync-detection probability. Given that Pm is the sync-error detecting probability and Ps is the disabled sync-detection probability, the sync error probability Pe is expressed by the following equation 1.

Pe=Pm+(1−Pm)Ps

=Pm(1−Ps)+Ps (1)

The sync detector 31 collates the collation pattern that coincides with the a target sync pattern with the read data and outputs the sync detection signal 310 when the number of unmatched symbols is equal to or smaller than a predetermined value or the allowable number of unmatched symbols. It is assumed here that the sync pattern which coincides with the sync pattern (original sync pattern) 502 recorded on the sector 500 is used as the collation pattern. The collation pattern in this case is called a standard sync pattern SS.

When the allowable number of unmatched symbols used in the sync detector 31 is set large, the sync-error detecting probability Pm becomes large and the disabled sync-detection probability Ps becomes small. That is, Pm is a monotonously increasing function and Ps is a monotonously decreasing function both with respect to the allowable number of unmatched symbols. Therefore, Pm(1−Ps) in the equation 1 is a monotonously increasing function with respect to the allowable number of unmatched symbols. It is understood from the above and the equation 1 that the allowable number of unmatched symbols has an optimal value.

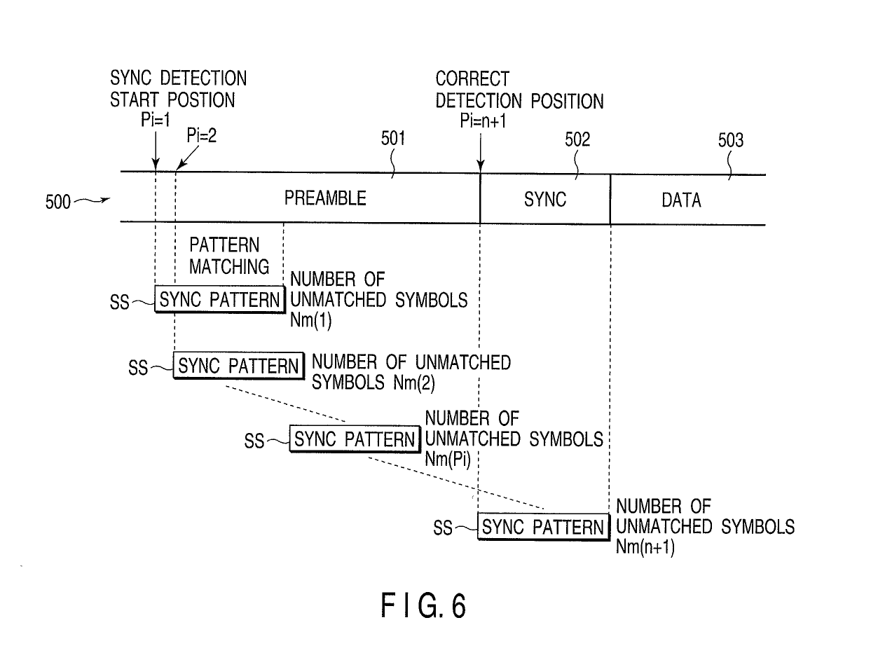

Pm (sync-error detecting probability) is also a function of the number of unmatched symbols, which will be discussed below referring to FIG. 6.

Let Nm(Pi) denote an unmatched symbol quantity. The value of Pi indicates the sync detection position. The initial value of Pi represents the position where sync detection starts (sync detection start position) as a result of the initial pulling of PLL being executed or the frequency of reproduced data being established based on the preamble pattern 501. In this example, Pi=1 at the sync detection start position. Every time the position moves by one symbol, Pi changes like Pi=2, 3, . . . , n+1. The position of Pi=n+1 is the correct sync detection position (the beginning of the sync pattern 502). “n” is equal to the number of symbols in the pattern portion after the sync detection start position. It is apparent from the above that Nm(Pi) represents the number of unmatched symbols between read data (the same number of symbols of the sync pattern 502) and the standard sync pattern SS (coincident with the sync pattern 502) starting at the position Pi when there is no noise. Therefore, the value of Nm(n+1) or the unmatched symbol quantity at the position of Pi=n+1 (correct sync detection position) is always “0”.

Apparently, as the value of the unmatched symbol quantity Nm(Pi) defined above becomes larger, the sync-error detecting probability Pm becomes smaller. That is, the sync-error detecting probability Pm is a monotonously increasing function with respect to the unmatched symbol quantity Nm(Pi). But, the disabled sync-detection probability Ps does not depend on the unmatched symbol quantity Nm(Pi).

It is apparent from those points and the equation 1 that the sync error probability Pe becomes smaller as the number of unmatched symbols gets larger. When the symbol error probability is sufficiently small, particularly, the sync error probability Pe is approximately determined by the minimum value of Nm(Pi) excluding Nm(n+1). To reduce the sync error probability Pe, therefore, the minimum value of Nm(Pi) excluding Nm(n+1) should be taken large.

The above shows that to reduce the sync error probability Pe, the number of unmatched symbols should be increased and the allowable number of unmatched symbols should be set to the optimal value. Note however that once the number of unmatched symbols is determined, the minimum value of the sync error probability is determined. It is therefore essential to increase the number of unmatched symbols in order to substantially improve the sync error probability Pe. To increase the number of unmatched symbols, it is effective to make the length of the sync pattern 502 (sync length) longer. Making the sync length longer leads to an undesirable reduction of the data format efficiency on the disk storage medium 50 as has been discussed in the section of BACKGROUND OF THE INVENTION.

To increase the number of unmatched symbols without lowering the data format efficiency, therefore, this embodiment takes the structure that allows the sync detector 31 to perform the sync detecting operation using an imaginary sync pattern (extended sync pattern to be discussed later) which is comprised of the sync pattern 502 and the end portion of the preamble pattern 501 preceding the sync pattern 502 instead of using the sync pattern 502 alone.

In general, the preamble pattern 501 is set to have an enough length for intentions, such as absorption of a variation in the rotation of the disk storage medium 50. At near the end of the preamble pattern 501, generally, the initial pulling-in of the PLL is already completed so that a reading operation can be carried out properly. This makes is possible to use the end portion of the preamble pattern 501 as an extended portion in the aforementioned imaginary sync pattern, with respect to the original sync pattern 502, i.e., a part of the imaginary sync pattern. In the following description, the “imaginary sync pattern” is called “extended sync pattern”. When the sync detection start position is shifted to the end portion of the preamble pattern 501 which is used as a part (extended portion) of the extended sync pattern due to a variation in the rotation of the disk storage medium 50, the sync pattern cannot be detected correctly and a retry operation will be performed. But, such a state does not continue steadily and it is very likely that in the retry operation, the sync detection start position comes before the end portion of the preamble pattern 501, allowing the extended sync pattern to be detected correctly.

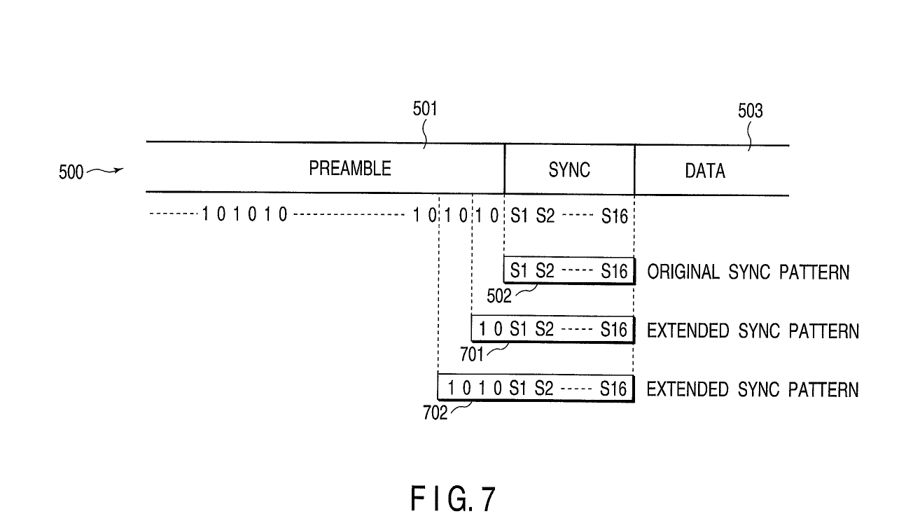

FIG. 7 shows an example in which (last) several symbols at the end portion of the preamble pattern 501 recorded right before the sync pattern 502 is used as a part of the extended sync pattern. In this example, given that the preamble pattern 501 is the repetition of “10” and the sync pattern 502 consists of 16 symbols of “S1 S2 . . . S16”, the last two or four symbols of the preamble pattern 501 are used as a part (start portion) of an extended sync pattern 701 or 702. The extended sync pattern 701 consists of the original sync pattern 502 and the last two symbols of the preamble pattern 501, while the extended sync pattern 702 consists of the original sync pattern 502 and the last four symbols of the preamble pattern 501.

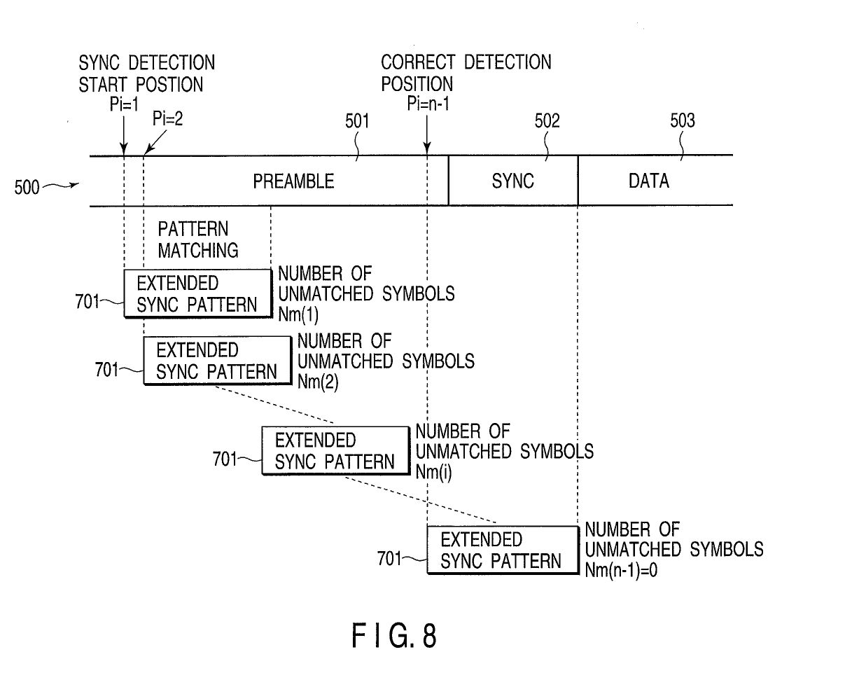

FIG. 8 illustrates the sync detection method employed in the sync detector 31 when the extended sync pattern 701 in FIG. 7, which consists of the original sync pattern 502 and the last two symbols of the preamble pattern 501, is used.

The sync detection method shown in FIG. 8 differs from the sync detection method shown in FIG. 6 that uses the original sync pattern 502 in the following two points. First, the substantially sync length becomes longer, and secondly, the correct sync detection position is shifted toward the preamble pattern 501. As the last two symbols of the preamble pattern 501 are used as a part of the extended sync pattern 701 (the extended portion with respect to the original sync pattern 502) in the example of FIG. 8, the sync length is longer by two symbols than that in the example of FIG. 6. Further, the correct sync detection position is shifted from Pi=n+1 to Pi=n−1 or the position preceding by two symbols. It is assumed in this embodiment that the number of last symbols of the preamble pattern 501 which are used as a part of the extended sync pattern is always constant both at the normal time and the retry time (induced by a read error or the like). That is, this embodiment uses the extended sync pattern that has a constant predetermined sync length.

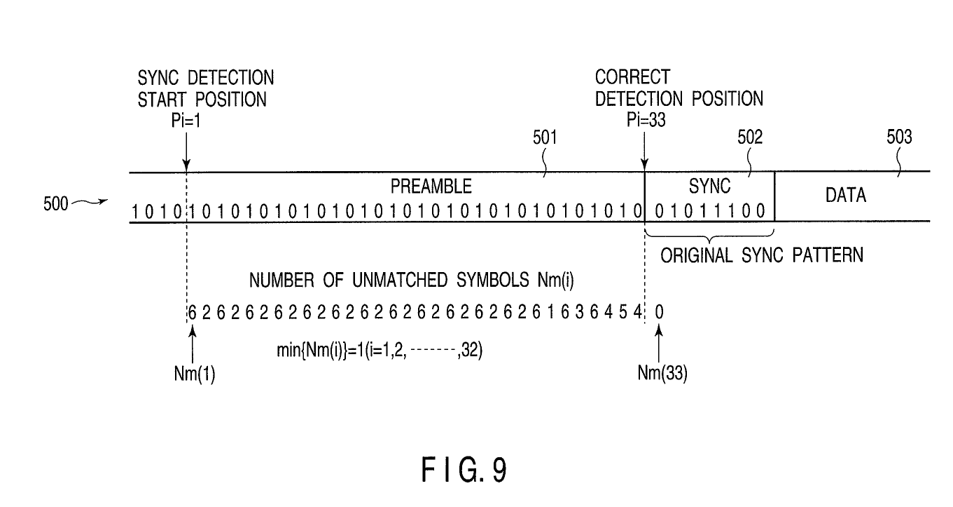

The advantages of the sync detecting operation performed by the sync detector 31 using the extended sync pattern will be discussed below in comparison with the sync detecting operation using the original sync pattern, by referring to FIGS. 9 to 14.

FIG. 9 shows the unmatched symbol quantity Nm(Pi) (Pi=1, 2, . . . , 33) when the sync detecting operation is executed using the original sync pattern 502 (the standard sync pattern SS coincident with the original sync pattern 502). It is assumed however that the length of the original sync pattern 502 (sync length) is 8 symbols, not 16 symbols in the example of FIG. 7, for the sake of diagrammatic convenience. It is also assumed that the pattern portion after the sync detection start position Pi=1 in the preamble pattern 501 consists of 32 symbols, the preamble pattern 501 is the repetition of “10” and the original sync pattern 502 is “01011100”.

It is apparent from the foregoing description that when the symbol error probability is sufficiently small, the sync error probability Pe greatly depends on the minimum value of Nm(Pi) excluding Nm(33). In the example of FIG. 9, the minimum value of Nm(Pi) is “1”.

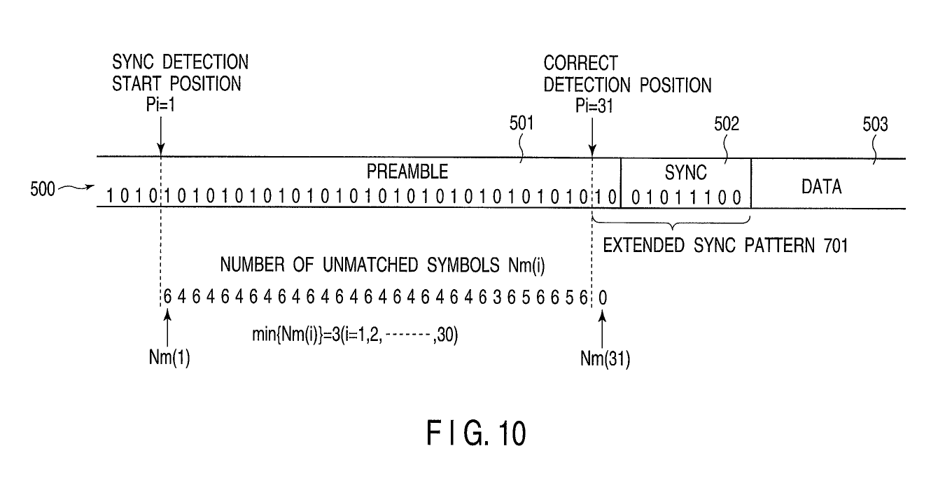

FIG. 10 depicts the unmatched symbol quantity Nm(Pi) (Pi=1, 2, . . . , 31) when the last two symbols of the preamble pattern 501 are used as a part of the extended sync pattern 701 under the same condition as given in the example of FIG. 9. In the example of FIG. 10, the minimum value of Nm(Pi) excluding Nm(31) is “3”, which is larger than the minimum value (=1) of Nm(Pi) when the sync detecting operation is carried out using the original sync pattern 502. As the length of the original sync pattern is set to 8 symbols, the length of the extended sync pattern 701 in the example of FIG. 10, unlike the length of the extended sync pattern 701 in FIG. 7, becomes 10 symbols.

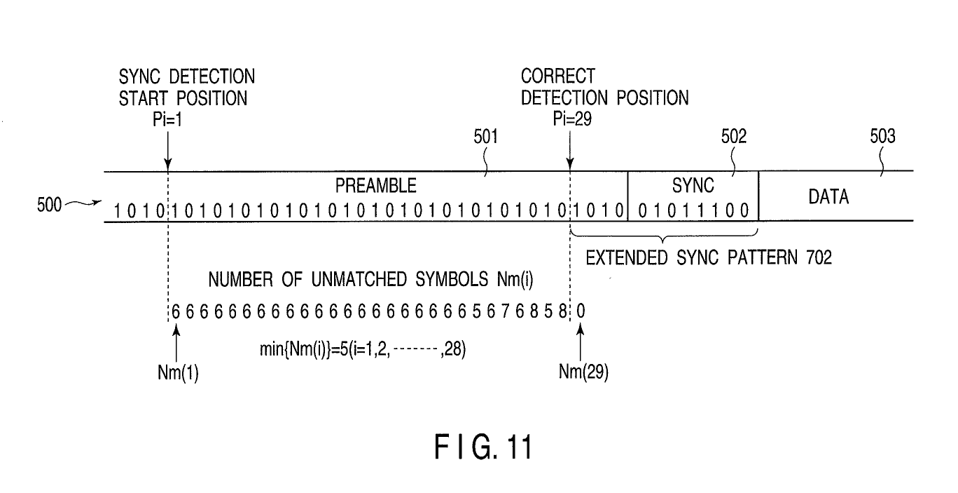

FIG. 11 depicts the unmatched symbol quantity Nm(Pi) (Pi=1, 2, . . . , 29) when the last four symbols of the preamble pattern 501 are used as a part of the extended sync pattern 701 under the same condition as given in the example of FIG. 9. In the example of FIG. 11, the minimum value of Nm(Pi) excluding Nm(29) is “5” which is larger than the minimum value (=3) of Nm(Pi) when the last two symbols of the preamble pattern 501 are used as a part of the extended sync pattern 701 in the example of FIG. 10.

As apparent from the above, the substantial sync length can be made longer by using a part (last several symbols) of the preamble pattern 501 preceding the original sync pattern 502 as a part of the extended sync pattern. This can allow the number of unmatched symbols to be made larger without lowering the data format efficiency, thus making the sync error probability Pe smaller, as in the example of FIG. 10 or FIG. 11, as compared with the sync detecting operation shown in FIG. 9 which uses the original sync pattern 502 alone.

The following will discuss the performance of the sync detection system that uses the extended sync pattern. For the sake of simplicity, each symbol of the extended sync pattern takes a binary value of “0” or “1”.

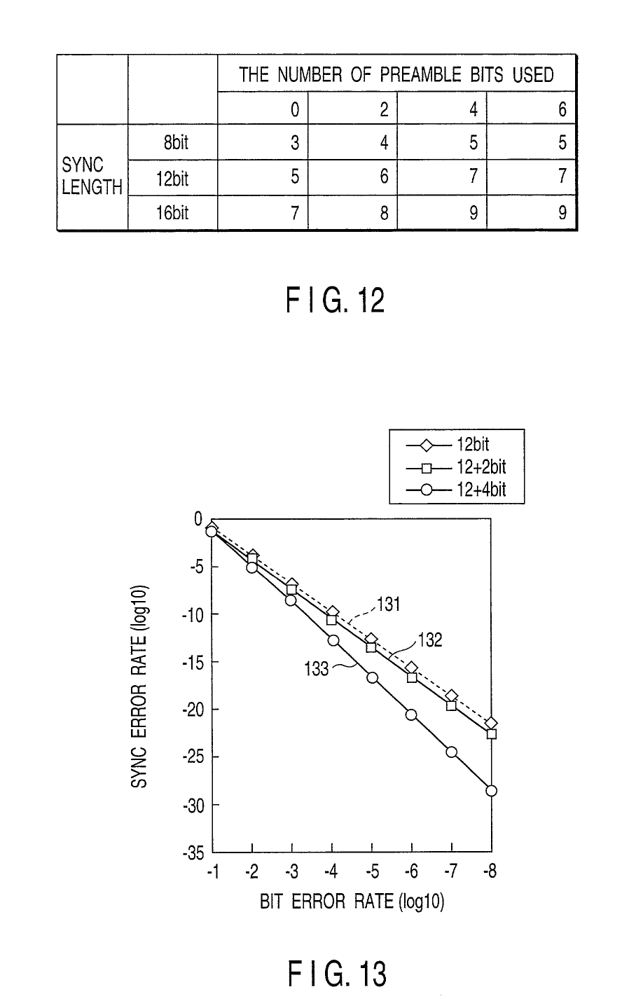

FIG. 12 shows a minimum number of unmatched bits, which has been obtained by using, as parameters, the sync length of the original sync pattern and the number of preamble bits used. The preamble bits used constitute a part of the preamble pattern or a part of the extended sync pattern. As the minimum number of unmatched bits differs depending on a sync pattern in use, the selection of the sync pattern is very important. FIG. 12 shows the results when the optimal sync pattern to maximize the minimum number of unmatched bits is used. In FIG. 12, every result indicates the minimum number of unmatched bits when the optimal sync pattern to maximize the minimum number of unmatched bits is used in each case.

The optimal sync pattern whose sync length is 8 bits and whose number of preamble bits used is “0”, “2”, “4” or “6” is “11011000”, “11011100”, “01011100” or “01011100”. The optimal sync pattern whose sync length is 12 bits and whose number of preamble bits used is “0”, “2”, “4” or “6” is “101101110000”, “000111011011”, “010101101100” or “010101101100”. The optimal sync pattern whose sync length is 16 bits and whose number of preamble bits used is “0”, “2”, “4” or “6” is “1011001111010000”, “1001011111001100”, “1101010010011011” or “0101001101100000”.

If the number of preamble bits used is “0” as shown in FIG. 12, the sync detecting operation is carried out by using the original sync pattern only. As apparent from FIG. 12, with the number of preamble bits used being the same, the longer the sync length is set, the greater the minimum number of unmatched bits becomes. It is apparent that even with the same sync length, the minimum number of unmatched bits is increased by using several bits (last several symbols) of the preamble pattern as a part of the extended sync pattern.

FIG. 13 shows the results of simulation of acquiring a sync error probability in the cases where the original sync pattern having a sync length of 12 bits. In this figure, the horizontal scale represents the bit error probability and the vertical scale represents the sync error probability. It is assumed here that a bit error is only a random error.

FIG. 13 shows a simulation result 131 when only the original sync pattern is used, a simulation result 132 when the extended sync pattern whose number of preamble bits used is “2”, is used and a simulation result 133 when the extended sync pattern whose number of preamble bits used is “4” is used.

As apparent from FIG. 13, the sync error probability can be significantly improved by performing the sync detecting operation using the extended sync pattern.

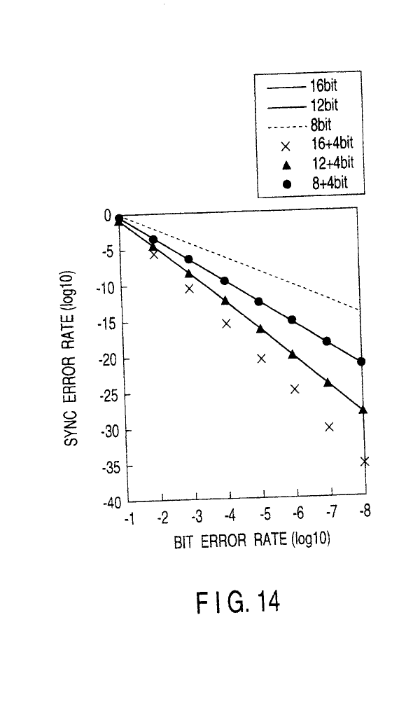

FIG. 14 shows the results of simulation of acquiring a sync error probability in the cases where each of original sync patterns having sync lengths of 8 bits, 12 bits and 16 bits was used alone and where the extended sync pattern whose number of preamble bits used was “4” was used. FIG. 14 shows the results in the case of using the original sync pattern alone by “lines” and the results in the case of using the extended sync pattern by “dots”. The “broken line” and “black circles” indicate the simulation results when the sync length is 8 bits, the “thin line” and “black triangles” indicate the simulation results when the sync length is 12 bits, and the “solid line” and “x” indicate the simulation results when the sync length is 16 bits.

The conditions for the sync length to achieve the desired sync error probability can be obtained from FIG. 14 for each bit error probability. To achieve a sync error probability of “−15” (in a logarithmic expression) when the bit error probability is “−5” (in a logarithmic expression), for example, a 16-bit sync length is needed when only the original sync pattern is used while a 12-bit sync length is needed in the case of using the extended sync pattern which uses four bits of the preamble pattern.

It is apparent from the above that the execution of the sync detecting operation using the extended sync pattern in this embodiment can significantly improve the sync error probability without lowering the data format efficiency. In other words, a higher data format efficiency can be ensured in achieving a certain sync error probability as compared with the structure that uses the original sync pattern alone.

Although a part of the preamble pattern is used as a part of the extended sync pattern in the above-described embodiment, this invention is not limited to this structure. For example, a magnetic disk drive which uses a sector data format having a fixed pattern other than a preamble pattern recorded before an original sync pattern can use a part (end portion) of the fixed pattern as a part of the extended sync pattern.

[First Modification of Extended Sync Pattern]

A magnetic disk drive which uses a sector data format having a fixed pattern recorded immediately after an original sync pattern can also use a part (start portion) of the fixed pattern as a part of the extended sync pattern. Unlike the above-described preamble pattern, the fixed pattern should not necessarily be common to all the sectors on the disk storage medium 50 but should at least correspond to each sector. In this case, however, the extended sync pattern (as a collation pattern) that is collated with read data by the sync detector 31 should be changed sector by sector.

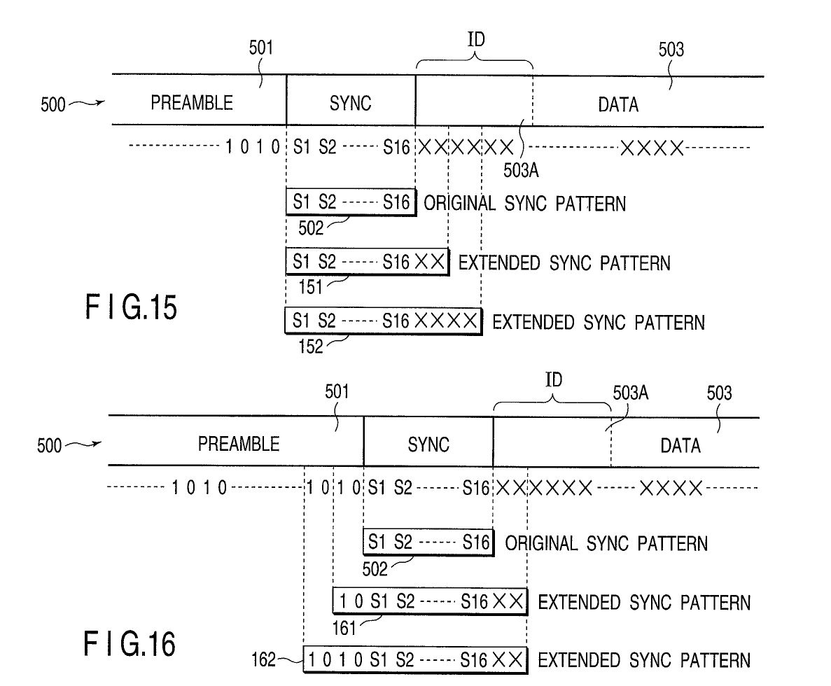

FIG. 15 shows an example where a part of data recorded immediately after the original sync pattern is used as a part of the extended sync pattern (first modification). This modification is premised on that a magnetic disk drive having the structure shown in FIG. 1 uses the sector data format in which an ID field 503A where an ID pattern (sector identification pattern) specific to each sector 500 is recorded is provided at the start portion (head portion) of the data field 503 in the sector 500. FIG. 15 shows an extended sync pattern 151 which uses the top two symbols of the ID pattern as a part of the sync pattern and an extended sync pattern 152 which uses the top four symbols of the ID pattern as a part of the sync pattern, together with the original sync pattern 502.

The substantial sync length can also be made longer by using a part of data immediately after the original sync pattern as a part of the extended sync pattern. This can reduce the sync error probability without lowering the data format efficiency.

[Second Modification of Extended Sync Pattern]

The first modification may be combined with the technical concept about the extended sync pattern that has been described in the foregoing description of the first embodiment. Specifically, not only a part of data (ID pattern) immediately after the original sync pattern but also a part of the preamble pattern immediately before the original sync pattern is used as a part of the extended sync pattern. Such an example (second modification) is illustrated in FIG. 16. FIG. 16 shows an extended sync pattern 161 which uses the last two symbols of the preamble pattern 501 and the top two symbols of the ID pattern in the ID field 503A as a part of the sync pattern and an extended sync pattern 162 which uses the last four symbols of the preamble pattern 501 and the top two symbols of the ID pattern in the ID field 503A as a part of the sync pattern, together with the original sync pattern 502.

The substantial sync length can also be made longer by using parts of data immediately before and after the original sync pattern as a part of the extended sync pattern. This can reduce the sync error probability without lowering the data format efficiency.

[Second Embodiment]

The second embodiment of this invention will now be discussed.

The feature of this embodiment lies in that in addition to the use of a part of the preamble pattern as a part of the extended sync pattern as per the first embodiment, the number of symbols in the preamble pattern that are used as a part of the sync pattern (the number of preamble bits used) is variable. More specifically, this embodiment is characterized in that a retry operation is executed while changing the number of symbols in the preamble pattern that are used as a part of the extended sync pattern.

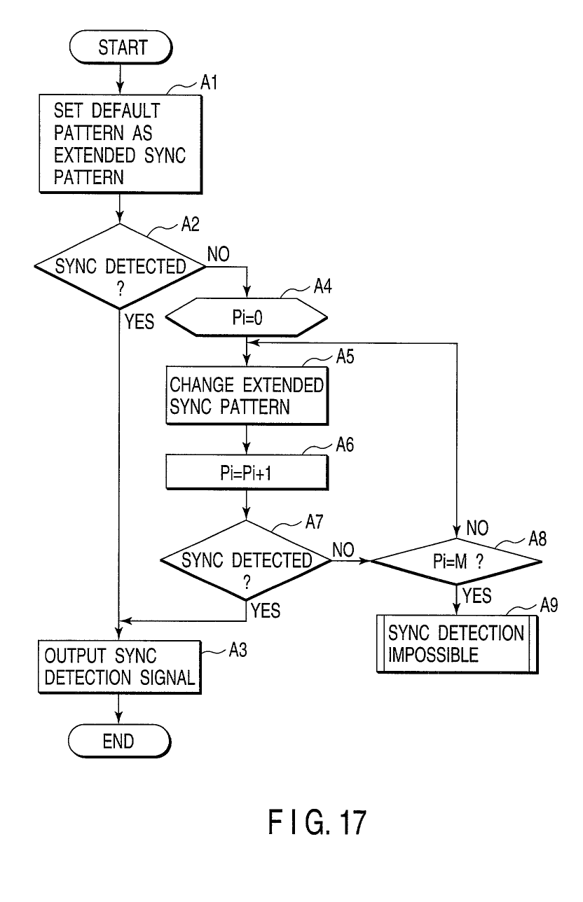

The details of the sync detection method in this embodiment will now be explained with reference to the flowchart in FIG. 17 and the structure in FIG. 1 whenever convenient. This description is premised on that the sync detector 31 executes the sync detecting operation according to the flowchart in FIG. 17 under the control of the CPU 2.

According to this embodiment, at the normal time, the sync detecting operation is carried out using a predetermined extended sync pattern (default extended sync pattern) (steps A1 and A2). More precisely, the data for the number of symbols, which corresponds to the length of the extended sync pattern (i.e., default extended sync pattern), is repeatedly extracted from that part of the read data which corresponds to a location following the detection start position. Each time the extraction is repeated, the extraction start position is shifted by one symbol. Every time data whose number of symbols coincides with the length of the extended sync pattern is extracted, the data is collated with the target extended sync pattern as a collation pattern to execute sync detection. The target extended sync pattern (collation pattern) is set by the CPU 2.

Whether or not the sync pattern has been detected correctly is determined by checking if the number of matched symbols detected in the aforementioned pattern collation is equal to or greater than a predetermined reference value. When the number of matched symbols is equal to or greater than the reference value, the sync detector 31 outputs the sync detection signal 310 indicative the correct detection of the sync pattern (step A3). When the number of matched symbols is smaller than the reference value, i.e., when the sync pattern is not detected correctly, on the other hand, a retry counter Pi for counting the number of retries is initialized to “0” (step A4). Then, the retry operation is performed.

In the retry operation, the retry counter Pi is incremented by one (Step A6). Next, an operation is performed to detect the sync pattern, and it is determined whether the sync pattern has been detected (Step A7). If the sync pattern has not been detected, the sync detector 31 outputs a sync detection signal 310 (Step A3).

When the sync detector 31 could not detect the sync pattern correctly, however, the CPU 2 determines if the retry number indicated by the retry counter Pi coincides with M, i.e., if the retry operation has been carried out the predetermined M times (step A8). If the retry number has not reached M, the retry operation takes place again to execute the sync detecting operation (steps A6 and A7). That is, the retry operation is repeated by a maximum of M times in this embodiment. When repeating the retry operation permits the sync pattern to be detected correctly, the retry operation is terminated and the sync detector 31 outputs the sync detection signal 310 (step A3).

If repeating the retry operation M times does not result in the correct detection of the sync pattern, on the other hand, sync detection is considered as impossible and the operation goes to an associated process (step A9).

The operation up to this point is the same as the sync detection in the first embodiment, except that the number of symbols in the preamble pattern that are used as a part of the extended sync pattern is made variable. In other words, according to the second embodiment, the CPU 2 changes the extended sync pattern in the direction of, for example, reducing the sync length (step A5) at the time of executing the sync detection process (step A7) in the retry operation. This can increase the probability that the sync pattern is detected correctly in the retry operation.

Although a part of the preamble pattern is used as a part of the extended sync pattern in the above-described embodiment, this invention is not limited to this case but other data may be used as well.

[Third Embodiment]

The third embodiment of this invention will now be discussed.

The feature of this embodiment lies in that the embodiment has a mode of executing the sync detecting operation using the original sync pattern alone and a mode of executing the sync detecting operation using part of the preamble pattern as a part of the extended sync pattern and executes the sync detecting operation by adequately switching one mode to the other. More specifically, this embodiment is characterized in that the sync detecting operation is carried out using different modes between the normal time and the retry time.

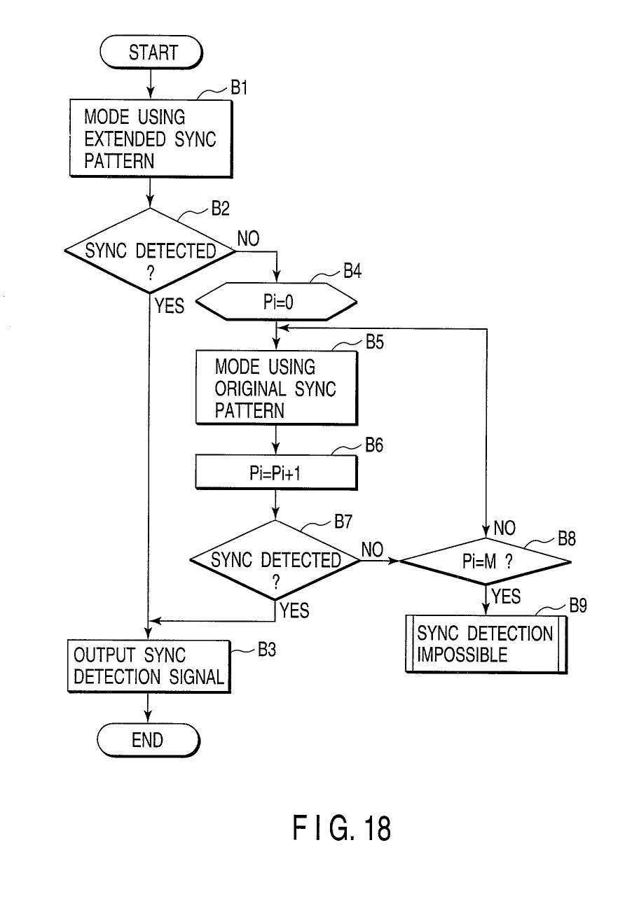

The details of the sync detection method in this embodiment will now be explained with reference to the flowchart in FIG. 18 and the structure in FIG. 1 whenever convenient. This description is premised on that the sync detector 31 executes the sync detecting operation according to the flowchart in FIG. 18 under the control of the CPU 2.

First, the sync detector 31 is set to the mode that uses the extended sync pattern (second mode) at the normal time under the control of the CPU 2 (step B1). Accordingly, the sync detector 31 executes the sync detecting operation in the second mode or the sync detecting operation using the extended sync pattern (step B2). When the sync pattern is detected correctly here, the sync detector 31 outputs the sync detection signal 310 (step B3).

When the sync pattern has not been detected correctly, on the other hand, a retry operation takes place. At the retry time, the sync detector 31 is set to the mode that uses the original sync pattern (first mode) under the control of the CPU 2 (step B5). Accordingly, the sync detector 31 executes the sync detecting operation in the first mode or the sync detecting operation using the original sync pattern (step B7). Then, the retry operation for the sync detecting operation using the original sync pattern is repeated by a maximum of M times (steps B6 to B8). When the sync pattern is detected correctly during this retry operation, the retry operation is terminated and the sync detector 31 outputs the sync detection signal 310 (step B3).

When the sync pattern is not detected correctly even if the retry operation is repeated M times, sync detection is considered as impossible and the operation goes to an associated process (step B9).

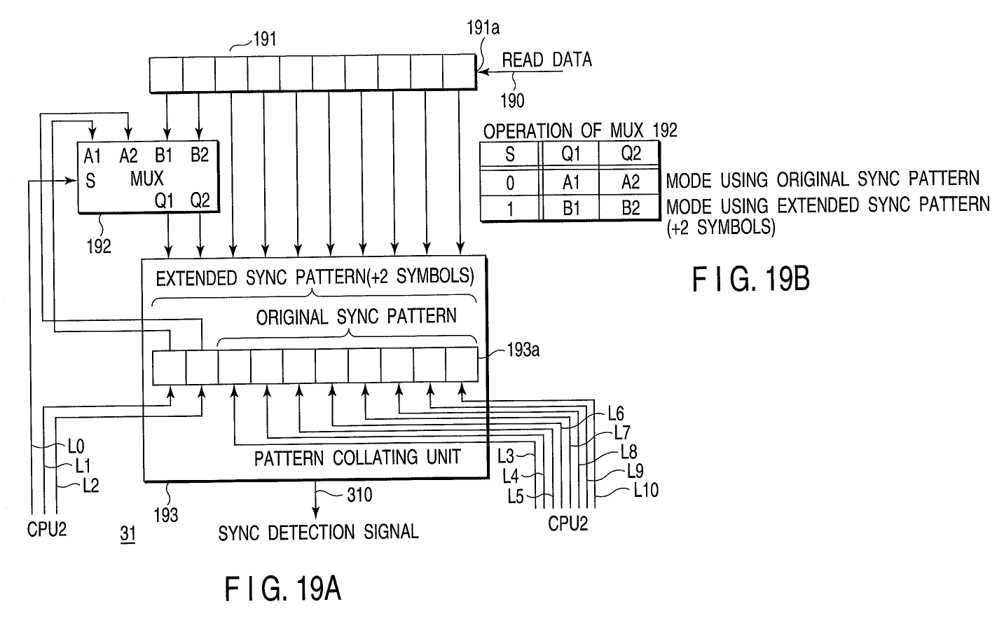

Referring to FIGS. 19A and 19B, the following will describe one example of the circuit structure of the sync detector 31 in FIG. 1 which is designed to perform the sync detecting operation while adequately switching the two modes from one to the other. This description will be given on the premise as per the example of FIG. 10 that the original sync pattern consists of 8 symbols and the extended sync pattern consists of 10 symbols, the original sync pattern plus two symbols recorded immediately before the original sync pattern (i.e., the last two symbols of the preamble pattern).

In the structure in FIG. 19A, read data 190 (which has been decoded by the R/W channel 3) is sequentially and serially input to a shift register 191 with the same number of stages as the number of symbols (10) of the extended sync pattern from a serial input terminal 191a. The data serially input to the serial input terminal 191a is output in parallel from ten delay elements of the shift register 191.

Of the ten delay elements of the shift register 191, two delay elements (the uppermost two delay elements) located opposite to the serial input terminal 191a are connected to one inputs B1 and B2 of a multiplexer (hereinafter referred to as “MUX”) 192 and the remaining eight delay elements (lower eight delay elements) are connected to a pattern collating unit 193. The other inputs A1 and A2 of the MUX 192 are connected to uppermost two symbol outputs of a collation pattern register 193a to be discussed later, and a selective control input S of the MUX 192 is connected to a signal line L0 for selective control.

The MUX 192 performs switching as shown in FIG. 19B in accordance with the logical status of the selective control input S. The MUX 192 selectively outputs the contents of the inputs A1 and A2 as outputs Q1 and Q2 when S=0 and selectively outputs the contents of the inputs B1 and B2 as the outputs Q1 and Q2 when S=1. The outputs Q1 and Q2 are connected to the pattern collating unit 193.

The pattern collating unit 193 incorporates the register (collation pattern register) 193a for holding a reference collation pattern for pattern collation. The size of this register 193a is equal to the number of symbols (10) of the extended sync pattern. The input of the register 193a is connected to signal lines L1 to L10. The CPU 2 sets 10 symbols of a collation pattern (target extended sync pattern) in the collation pattern register 193a via the signal lines L1-L10. The collation pattern register 193a may be provided outside the pattern collating unit 193.

The operation of the sync detector 31 with the structure shown in FIG. 19A will be explained with reference to the case where the operation is performed in the mode that uses the original sync pattern.

The CPU 2 sets the signal line LO to a logic “0” or sets the selective control input S of the MUX 192 in the sync detector 31 to the logic “0”, thereby designating the mode that uses the original sync pattern (first mode) to the sync detector 31. In the first mode, the MUX 192 selectively outputs the contents of the inputs A1 and A2 as the outputs Q1 and Q2 according to S=0. The contents of the inputs A1 and A2 of the MUX 192 are the contents of the uppermost two symbols held in the collation pattern register 193a or the uppermost two symbols of the collation pattern (extended sync pattern).

The contents of the outputs Q1 and Q2 of the MUX 192 are input to the pattern collating unit 193 together with the outputs (read data) of the eight delay elements of the shift register 191 excluding the uppermost two, i.e., the outputs (read data) of the lower eight delay elements of the shift register 191. The pattern collating unit 193 collates the 10-symbol input with the collation pattern held in the collation pattern register 193a and counts the number of matched symbols to detect the sync pattern. When detecting the sync pattern correctly, the pattern collating unit 193 outputs the sync detection signal 310 indicating that event. Here, the contents of the uppermost two symbols in the 10-symbol input to be collated with the collation pattern or the contents of the outputs Q1 and Q2 of the MUX 192 are the contents of the inputs A1 and A2 of the MUX 192 or the outputs of the uppermost two symbols of the collation pattern. When S=0, therefore, pattern collation in the pattern collating unit 193 is equivalent to collation of the outputs (read data) of the lower eight symbols of the shift register 191 with the lower eight symbols of the collation pattern. This can allow the sync detecting operation to be implemented by using the original sync pattern.

It will be described how the sync detector 31 operated in the mode that uses the extended sync pattern. The CPU 2 sets the signal line L0 to a logic “1” or sets the selective control input S of the MUX 192 in the sync detector 31 to the logic “1”, thereby designating the mode that uses the extended sync pattern (second mode) to the sync detector 31. In the second mode, the MUX 192 selectively outputs the contents of the inputs B1 and B2 as the outputs Q1 and Q2 according to S1. The contents of the inputs B1 and B2 of the MUX 192 are the contents of the uppermost two symbols in the parallel outputs from the shift register 191.

The contents of the outputs Q1 and Q2 of the MUX 192 are input to the pattern collating unit 193 together with the lower eight symbols in the parallel outputs from the shift register 191. That is, 10 symbols of parallel outputs (read data) from the shift register 191 are input to the pattern collating unit 193. The pattern collating unit 193 collates the 10-symbol input with the collation pattern held in the collation pattern register 193a and counts the number of matched symbols to detect the sync pattern. This can allow the sync detecting operation to be implemented by using the extended sync pattern.

Instead of the MUX 192, two multiplexers each having a single input and a single output may be provided. In this case, one of the multiplexers switches the uppermost one symbol in the parallel outputs from the shift register 191 and one corresponding symbol in the collation pattern in accordance with the status of the signal line L0 (S input). The other multiplexer switches the next symbol to the uppermost symbol in the parallel outputs from the shift register 191 and one corresponding symbol in the collation pattern in accordance with the status of the signal line L0 (S input).

In the above case, two symbols in the preamble pattern are used as a part of the extended sync pattern. In the case of X symbols, the MUX (192) designed to have X inputs and outputs has only to be used. Alternatively, X multiplexers each having a single input and a single output may be provided. By switching the X multiplexers individually, the number of symbols in the preamble pattern that are used as a part of the extended sync pattern can easily be made variable (the length of the extended sync pattern can be made variable) as realized in the second embodiment.

In the example of FIG. 15 where two symbols recorded immediately after the original sync pattern are used, the inputs B1 and B2 (B inputs) of the MUX 192 have only to be connected to the lowermost two delay elements of the shift register 191 while the remaining eight delay elements (upper eight delay elements) are connected to the pattern collating unit 193. In this example, the inputs Al and A2 (A inputs) of the MUX 192 are connected to the lowermost two symbol outputs of the collation pattern register 193a and the outputs Q1 and Q2 (Q outputs) of the MUX 192 are connected to corresponding inputs (lowermost two symbol inputs) of the pattern collating unit 193.

In the case where the original sync pattern consists of L symbols and X1 symbols recorded immediately before the original sync pattern and X2 symbols recorded immediately after the original sync pattern (X1+X2=X) are used as a part of the extended sync pattern, an MUX (192) having X symbol inputs and outputs, and a shift register (191) and a collation pattern register (193a) both having a size of L+X symbols should be used. In this case, the B inputs of the MUX (192) are connected to the uppermost X1 symbols and the lowermost X2 symbols in the parallel outputs from the shift register (191) and the remaining L symbols in the parallel outputs are connected to the pattern collating unit 193. Further, the A inputs of the MUX (192) are connected to the uppermost X1 symbol outputs and the lowermost X2 symbol outputs of the collation pattern register (193a) and the Q outputs of the MUX (192) are connected to the associated inputs of the pattern collating unit (193). It is also possible to provide two multiplexers, one for the uppermost X1 symbols of the shift register (191) and the other for the lowermost X2 symbols of the shift register. Furthermore, a multiplexer having a single symbol input and a single symbol output may be provided for each of the uppermost X1 symbols and the lowermost X2 symbols of the shift register (191).

Although at the retry time, the above-described third embodiment performs the sync detecting operation only in the mode that uses the original sync pattern, the sync detecting operation may be executed using both of the aforementioned two modes (first and second modes). For example, feasible schemes include a scheme of executing the sync detecting operation by switching the mode from one to the other for each retry, and a scheme of executing the sync detecting operation in one of the modes until an N-th retry operation (N<M) and switching the mode to the other thereafter (M being the maximum retry times). In this case, the scheme of changing the length of the extended sync pattern during the retry operation as discussed in the foregoing description of the second embodiment may be used together.

Although the foregoing description of this embodiment has been given of the case where the sync detecting operation is normally carried out using the extended sync pattern but it is carried out using the original sync pattern at the retry time, the use of the sync pattern may be reversed.

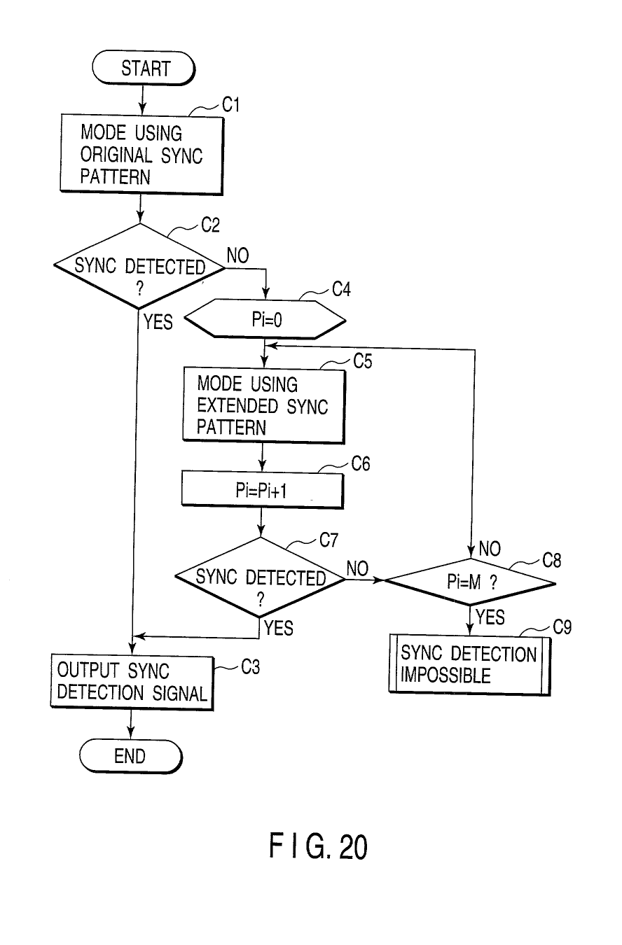

The following will discuss a modification of this embodiment which executes the sync detecting operation using different modes between the normal time and the retry time with reference to the flowchart in FIG. 20. Specifically, the sync detecting operation is normally carried out using the original sync pattern and is carried out using the extended sync pattern at the retry time.

In this modification, sync detection is normally carried out in the mode that uses the original sync pattern (steps Cl and C2). When the sync pattern is detected correctly, the sync detection signal 310 is output (step C3).

When the sync pattern is not detected correctly, a retry operation takes place. At the retry time, sync detection is carried out in the mode that uses the extended sync pattern (steps C5, C6 and C7). Then, the retry operation is repeated for the sync detecting operation that uses the extended sync pattern by a maximum of M times (steps C6-C8). When repeating the retry operation results in the correct detection of the sync pattern, the retry operation is terminated and the sync detection signal 310 is output (step C3).

When the sync pattern is not detected correctly even if the retry operation is repeated M times, sync detection is considered as impossible and the operation goes to an associated process (step C9).

Although the sync detecting operation is performed, at the retry time, only in the mode that uses the extended sync pattern in the above-described modification, the sync detecting operation may be performed using both of the two modes (first and second modes). Further, the scheme of changing the length of the extended sync pattern during the retry operation may be used together.

Although the foregoing description of the third embodiment has been given of the case where a part of the preamble pattern is used as a part of the extended sync pattern, this invention is not limited to this case. For example, a part of the ID pattern as shown in FIG. 15 may be used or a part of the preamble pattern and a part of the ID pattern as shown in FIG. 16 may be used together. That is, a part of data recorded immediately after the original sync pattern or parts of data recorded immediately before and after the original sync pattern may be used.

Although the foregoing description of the individual embodiments has been given of the case where this invention is adapted to a magnetic disk drive, this invention may be adapted to general data storage systems, such as an optical disk drive, magneto-optical disk drive, CD-ROM drive, floppy disk drive and magnetic tape drive, that can read data from a storage medium on which user data is recorded in recording areas of a predetermined size and a sync pattern is recorded in each recording area.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sync detector for use in a data storage system capable of reading data from a storage medium on which user data is recorded in recording areas of a predetermined size and an original sync pattern is recorded in each of the recording areas, comprising:
input means for receiving read data from the storage medium,
a pattern collating unit for performing a sync detecting operation of detecting an extended sync pattern comprised of first and second sync patterns from the read data supplied from the input means, the first sync pattern being the original sync pattern while the second sync pattern is at least one of an end part of recorded data immediately before the original sync pattern and a top part of recorded data immediately after the original sync pattern.

2. The sync detector according to claim 1, further comprising switch means for changing a number of symbols of data used as the second sync pattern.

3. The sync detector according to claim 1, further comprising switch means for fixing a number of symbols of data used as the second sync pattern at a normal time and changing the number of symbols at a retry time.

4. The sync detector according to claim 1, wherein:
said sync detector further comprises switch means for switching between a first mode for performing the sync detecting operation using the original sync pattern alone and a second mode for performing the sync detecting operation using the extended sync pattern; and
said pattern collating unit carries out the sync detecting operation to detect the original sync pattern as a target in the first mode and carries out the sync detecting operation to detect the extended sync pattern as a target in the second mode.

5. The sync detector according to claim 1, wherein:
said sync detector further comprises switch means for switching between a first mode for performing the sync detecting operation using the original sync pattern alone and a second mode for performing the sync detecting operation using the extended sync pattern at a normal time, whereby the sync detecting operation in the second mode is enabled at a normal time and the sync detecting operation in the first mode is enabled at a retry time; and
said pattern collating unit carries out the sync detecting operation to detect the original sync pattern as a target in the first mode and carries out the sync detecting operation to detect the extended sync pattern as a target in the second mode.

6. The sync detector according to claim 1, wherein:
said sync detector further comprises switch means for switching between a first mode for performing the sync detecting operation using the original sync pattern alone and a second mode for performing the sync detecting operation using the extended sync pattern, whereby the sync detecting operation in the second mode is enabled at a normal time and the sync detecting operation is carried out by switching the first mode and the second mode from one to the other at a retry time; and
said pattern collating unit carries out the sync detecting operation to detect the original sync pattern as a target in the first mode and carries out the sync detecting operation to detect the extended sync pattern as a target in the second mode.

7. The sync detector according to claim 1, wherein:
said sync detector further comprises switch means for switching between a first mode for performing the sync detecting operation using the original sync pattern alone and a second mode for performing the sync detecting operation using the extended sync pattern, whereby the sync detecting operation in the first mode is enabled at a normal time and the sync detecting operation in the second mode is enabled at a retry time; and
said pattern collating unit carries out the sync detecting operation to detect the original sync pattern as a target in the first mode and carries out the sync detecting operation to detect the extended sync pattern as a target in the second mode.

8. The sync detector according to claim 1, wherein:
said sync detector further comprises switch means for switching between a first mode for performing the sync detecting operation using the original sync pattern alone at a retry mode and a second mode for performing the sync detecting operation using the extended sync pattern at a normal time, whereby the sync detecting operation in the first mode is enabled at a normal time and the sync detecting operation is carried out by switching the first mode and the second mode from one to the other at a retry time; and
said pattern collating unit carries out the sync detecting operation to detect the original sync pattern as a target in the first mode and carries out the sync detecting operation to detect the extended sync pattern as a target in the second mode.

9. The sync detector according to claim 1, wherein:
said input means is a shift register for sequentially receiving read data from the storage medium in a serial form and providing parallel outputs;
said sync detector further comprises:
a collation pattern register for holding a collation pattern identical to the extended sync pattern; and
a multiplexer for receiving a part of the parallel output of the shift register and a part of the collation pattern held in the collation pattern register, and for selecting the part of parallel output or the part of the collation pattern; said part of the parallel output corresponding to the data used as the second sync pattern, and said part of the collation pattern corresponding to the data used as the second sync pattern, and
said pattern collating unit receives a pattern comprised of a output in said parallel outputs of said shift register which corresponds to a position of data of the original sync pattern and a selected output of the switch means and collating said input pattern with the collation pattern in said collation pattern register to thereby detect the extended sync pattern.

10. The sync detector according to claim 1, wherein:
said input means is a shift register for receiving the read data from the storage medium in a serial form and for outputting parallel data, said sift register having as many stages as the largest number of symbols the extended sync pattern can have;
said sync detector further comprises:
a collation pattern register for holding a collation pattern identical to the extended sync pattern that has the largest number of symbols; and
a multiplexer for varying the number of symbols that is used as the second sync pattern, for receiving a part of the parallel output of the shift register and a part of the collation pattern held in the collation pattern register, and for selecting the part of the parallel output or the part of the collation pattern, said part of the parallel output corresponding to the data used as the second sync pattern when the extended sync pattern has the largest number of symbols, and said part of the collation pattern corresponding to the data used as the second sync pattern, and
said pattern collating unit receives a pattern composed of the parallel output of the shift register, which corresponds to the data position of the original sync pattern, and the selected output of the multiplexer, and collates the pattern with the collation pattern held in the collation pattern register, thereby to detect the extended sync pattern.

11. A data storage system comprising:
a storage medium on which user data is recorded in recording areas of a predetermined size and an original sync pattern is recorded in each of the recording areas; and
a sync detector for performing a sync detecting operation, said sync detector including a pattern collating unit for detecting an extended sync pattern comprised of first and second sync patterns from read data from the storage medium, the first sync pattern being the original sync pattern while the second sync pattern is at least one of an end part of recorded data immediately before the original sync pattern and a top part of recorded data immediately after the original sync pattern.

12. The data storage system according to claim 11, wherein said sync detector includes switch means for changing a number of symbols of data used as the second sync pattern.

13. The data storage system according to claim 12, further comprising control means for controlling said switch means in said sync detector.

14. A sync detection method for use in a data storage system capable of reading data from a storage medium on which user data is recorded in recording areas of a predetermined size and an original sync pattern is recorded in each of the recording areas, the method comprising the steps of:
receiving read data from the storage medium; and
detecting an extended sync pattern comprised of first and second sync patterns from the read data, the first sync pattern being the original sync pattern while the second sync pattern is at least one of an end part of recorded data immediately before the original sync pattern and a top part of recorded data immediately after the original sync pattern.

15. The sync detector according to claim 14, wherein the step of the detecting comprise the steps of:
repeating an operation of extracting those symbols of data whose quantity coincides with a length of the extended sync pattern from the read data, while shifting an extraction start position by one symbol; and
collating the extracted data with a collation pattern coincident with the extended sync pattern every time the symbols of data whose quantity coincides with the length of the extended sync pattern are extracted.

16. The sync detection method according to claim 14, wherein a number of symbols of data used as the second sync pattern is variable.

17. The sync detection method according to claim 14, wherein a number of symbols of data used as the second sync pattern is fixed at a normal time and is changed at a retry time.
